(19) United States
(12) Patent Application Publication
(10) Pub. No.: US 2002/0116220 A1
(43) Pub. Date: Aug. 22, 2002

(54) Method and system for interactively researching and scheduling a medical procedure over a computer network

(76) Inventor: Alan Neil Glazier, Rockville, MD (US)

Correspondence Address: Robin C. Clark, Esq., Hunton & Williams, Suite 1200, 1900 K Street, N.W., Washington, DC, 20006, US

(21) Appl. No.: 09/789,295

(22) Filed: Feb. 20, 2001

(51) Int. Cl. G06F 17/60

(52) U.S. Cl. 705/2

(57) ABSTRACT

A system and method for enabling interactive research and scheduling of medical procedures over a computer network. A server computer receives, from a client computer associated with a user, a request for medical procedure information relating to at least one medical procedure. In response to this request, the server computer retrieves, from at least one database, the corresponding medical procedure information. Once the information has been retrieved, the computer server displays the medical procedure information to the client computer. Next, the server computer receives, from said client computer, a request to schedule an appointment relating to the medical procedure. In response to this request, the server computer receives, from the client computer, appointment information relating to the desired appointment. Once the appointment has been received, the server computer displays an appointment confirmation to the client computer.

### BACKGROUND OF THE INVENTION

The present invention relates generally to on-line systems for providing research and scheduling services to users. More particularly, the present invention relates to a method and system for enabling users to research and schedule medical procedures in an on-line environment.

Due to recent advancements in cosmetic and vision enhancement procedures, the field of elective medical procedures has enjoyed ever increasing success and participation from the general public. The term elective medical procedure generally includes any surgical procedure designed to enhance an individual's appearance or improve an individual's quality of life although not immediately medically necessary.

Unfortunately, the prospect of participating in an elective medical procedure is typically one approached with a certain degree of trepidation and anxiety by prospective patients. Initially, prospective patients may be curious about available procedures and the benefits and risks associated therewith. Generally, prospective patients must discern this type of information from magazines, books, or other time consuming and conventional mediums. Next, once a prospective patient has identified a particular procedure to investigate further, questions arise regarding the location and selection of a qualified surgeon. Once again, an exhaustive search must be conducted using conventional means such as local doctor directories, phone books, word of mouth referrals, etc. Finally, after a suitable surgeon has been selected, the surgeon's office must be personally contacted by the prospective patient to determine availability and to set up a consultation. An additional concern for prospective patients is that elective procedures are not covered by conventional insurance plans, thereby rendering cost a significant factor in determining whether a prospective patient will proceed with the procedure. Patients often must inquire into loans or other financing arrangements in order to secure payment for the procedure.

In addition to patient confusion and concern in the area of elective medical procedures, companies offering or considering offering related services also suffer from many of the same problems. In particular, businesses struggle to attract and maintain employees and clients in today's increasingly competitive marketplace. In order to do so, businesses are continually exploring new and unique employment benefits and product/service offerings. Relating this to elective medical procedures, employers may choose to offer an elective surgery benefit to employees. Correspondingly, insurance carriers and health care providers may choose to establish and participate in such plans in order to increase their own businesses. However, the task of matching employers, insurance carriers, and health care providers united in these efforts is not an easy task.

Accordingly, there is a need in the art of elective medical procedures for a single, comprehensive environment for providing prospective patients with procedure research capabilities, surgeon location capabilities, and appointment scheduling capabilities.

There is a further need in the art for an environment wherein employers, insurance carriers, and health care providers are connected with respect to elective procedure insurance benefits so as to increase the respective market potential for each of these entities.

### BRIEF SUMMARY OF THE INVENTION

The present invention overcomes the problems noted above, and provides additional advantages, by providing a method and system for enabling interactive research and scheduling of medical procedures over a computer network. A server computer receives, from a client computer associated with a user, a request for medical procedure information relating to at least one medical procedure. In response to this request, the server computer retrieves, from at least one database, the corresponding medical procedure information. Once the information has been retrieved, the computer server displays the medical procedure information to the client computer. Next, the server computer receives, from said client computer, a request to schedule an appointment relating to the medical procedure. In response to this request, the server computer receives, from the client computer, appointment information relating to the desired appointment. Once the appointment has been received, the server computer displays an appointment confirmation to the client computer.

Further aspects of the present invention will become apparent during the course of the following description and by reference to the attached drawings.

### BRIEF DESCRIPTION OF THE DRAWINGS

The present invention can be understood more completely by reading the following Detailed Description of exemplary embodiments, in conjunction with the accompanying drawings, in which:

FIG. 1 is a block diagram of a computer network suitable for implementing a method and system according to the present invention;

FIG. 2 is a flow chart describing one embodiment of a method for providing medical procedure information and scheduling services over the computer network of FIG. 1;

FIG. 3 is a flow chart describing one embodiment of a method for providing medical procedure information over the computer network of FIG. 1;

FIG. 4 is a flow chart describing one embodiment of a method for providing medical procedure scheduling services over the computer network of FIG. 1;

FIG. 5 is a flow chart describing one embodiment of a method for scheduling an appointment for a medical procedure or consultation over the computer network of FIG. 1;

FIG. 6 is a flow chart describing one embodiment of a method for providing online financing of a medical procedure over the computer network of FIG. 1; and FIG. 7 is a flow chart describing one embodiment of a method for providing business to business solutions between insurance carriers, employers, and health care providers over the computer network of FIG. 1.

### DETAILED DESCRIPTION OF THE INVENTION

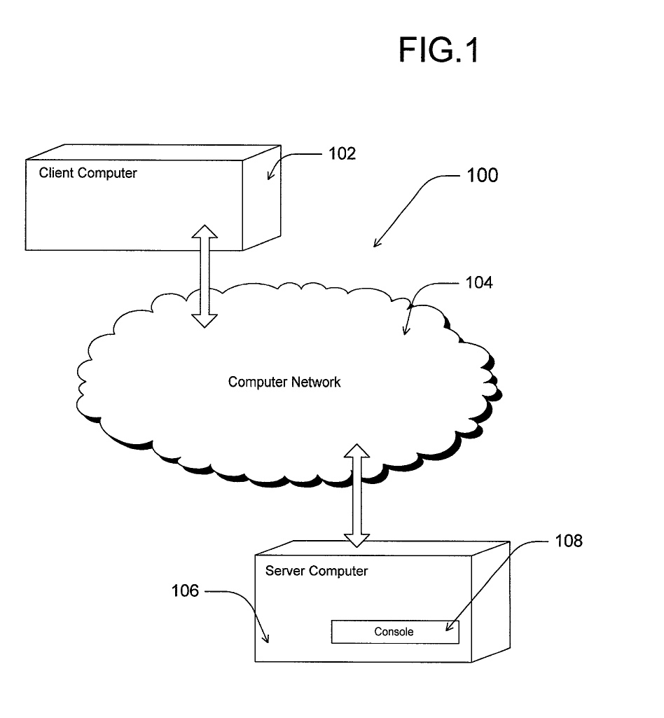

An Internet computer system 100 is generally illustrated in FIG. 1. A conventional client computer system 102, executing a client browser application that supports the HTTP protocol, is connected typically through a network service provider to a suitable computer network 104 such as the Internet.

Client computer system 102 may include, for instance, a personal computer running the Microsoft Windows™ 95, 98, Millenium™, NT™, or 2000, Windows™ CE™, PalmOS™, Unix, Linux, Solaris™, OS/2™, BeOS™, MacOS™ or other operating system or platform. Client computer system 102 may also include a microprocessor such as an Intel x86-based device, a Motorola 68K or PowerPC™ device, a MIPS, Hewlett-Packard Precision™, or Digital Equipment Corp. Alpha™ RISC processor, a microcontroller or other general or special purpose device operating under programmed control. Furthermore, client computer system 102 may include electronic memory such as RAM (random access memory) or EPROM (electronically programmable read only memory), storage devices such as a hard drive, CDROM or rewritable CDROM or other magnetic, optical or other media, and other associated components connected over an electronic bus, as will be appreciated by persons skilled in the art. Client computer system 102 may also include a network-enabled appliance such as a WebTV™ unit, radio-enabled Palm™ Pilot or similar unit, a set-top box, a networkable game-playing console such as Sony Playstation™ or Sega Dreamcast™, a browser-equipped cellular telephone, or other TCP/IP client or other device.

In addition to the Internet, suitable computer networks may also include or interface with any one or more of, for instance, an local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, computer network 104 may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. Computer network 104 may yet further include or interface with any one or more of an RS-232 serial connection, an IEEE-1394 (Firewire) connection, a Fibre Channel connection, an IrDA (infrared) port, a SCSI (Small Computer Systems Interface) connection, a USB (Universal Serial Bus) connection or other wired or wireless, digital or analog interface or connection.

A server computer system 106 is also coupled typically through an Internet Service Provider to the Internet 104. The server computer system 106 may be or include, for instance, a workstation running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. The server computer system 106, controlled by a local console 108, executes at least one web server application conventionally known as a HTTPd server. In addition, the server computer system 106 preferably provides local storage for at least one, though typically many, web pages. Also, server computer system 106 may include several individual server computers at various locations on the network.

The client computer system requests a web page by issuing a URL request through the Internet 104 to the server system 106. A URL consistent with the present invention may be a simple URL of the form:

<protocol_identifier>://<server_path>/<web_page_path>

A “protocol_identifier” of “http” specifies the conventional hyper-text transfer protocol. A URL request for a secure Internet communication session typically utilizes the secure protocol identifier “https,” assuming that the client browser and web server each support and implement the secure sockets layer (SSL). The “server_path” is typically of the form “prefix.domain,” where the prefix is typically “www” to designate a web server and the “domain” is the standard Internet sub-domain.top-level-domain of the server system 106. The optional “web_page_path” is provided to specifically identify a particular hyper-text page maintained by the web server.

In response to a received URL identifying an existing web page, the server system 106 returns the web page, subject to the HTTP protocol, to the client computer system 102. This web page typically incorporates both textural and graphical information including embedded hyper-text links, commonly referred to as hyperlinks, that permit the client user to readily select a next URL for issuance to the Internet 104.

The URL issued from the client system 102 may also be of a complex form that identifies a common gateway interface (CGI) program on a server system 106. Such a HTML hyperlink reference is typically of the form:

<form action=“http://www.vendor.com/cgi-bin/logon.cgi” method=post>

A hyper-text link of this form directs the execution of the logon.cgi program on an HTTP server in response to a client-side selection of the hyperlink. A logon form supported by a logon CGI program is typically used to obtain a client user login name and password to initiate an authenticated session between the client browser and web server for purposes of supporting, for example, a secure purchase transaction or a secure communications session.

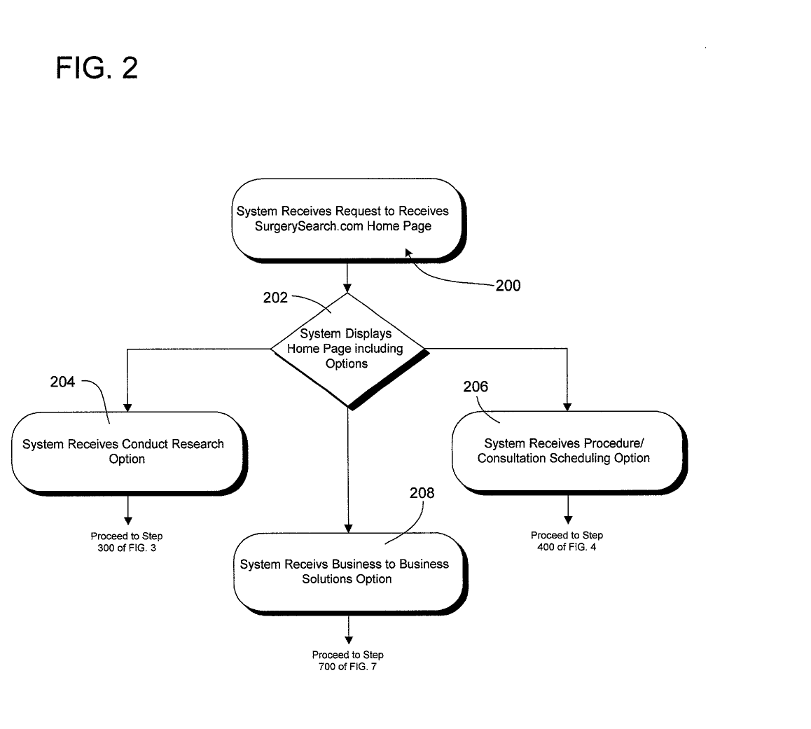

Referring now to FIG. 2, there is shown a flow chart describing one embodiment of a method for interactively presenting elective surgery and related information to a user over a computer network such as the Internet. Preferably, the method and system described below is implemented by a computer software program, such as a web server application, resident on one or more server computers (such as server computer system 106, described above) associated with a content provider. Preferably, such a web server application is utilized to create and maintain a plurality of dynamically interactive web pages on the server computers. In a preferred embodiment, users of the education service are connected to the service web pages through a plurality of client computers (such as client computer system 102) over the computer network. In this manner, service users may remotely interact with the service to obtain, exchange, or modify information as more fully set forth in detail below.

Although not limited thereto, computer software programs for implementing the present method may be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

In step 200, the content provider's server computer system (hereinafter generally referred to as “the system”) receives a request from a user's client computer system (hereinafter referred to as “the user”) to display a SurgerySearch.com home page which briefly describes the nature of the services and features provided by the system and which includes thereon a plurality of user options, or hyperlinks, the selection of which results in user navigation to the selected content item or feature. “SurgerySearch.com” is a name used throughout this application in association with the system and method of the present invention and is a trademark of SurgerySearch.com, a Maryland company with offices in Rockville, Md.

As is known in the art, a home page is, generally speaking, the first page of a web site, or a collection of related web pages and provides a starting point for enabling a user to navigate through the site in an orderly, user-friendly manner. Accordingly, the SurgerySearch.com home page is a starting point for the elective surgery research and scheduling system of the present invention. In step 202, the system displays the home page on the user's client computer system via the computer network in the manner described above. Following display of the home page, the user may select from a plurality of options generally related to elective surgery research as well as specific scheduling of a particular surgery or procedure.

In particular, relating to elective surgery or procedure research, one preferred embodiment of the home page displayed in step 202 provides options relating to elective procedure research as well as the scheduling and preparing for consultations and procedures. It should be understood that the above-described options may be displayed to users on a single web page interface or under discrete web page interfaces corresponding generally to the research and scheduling options, respectively. In this manner, any desired level of page simplicity may be obtained.

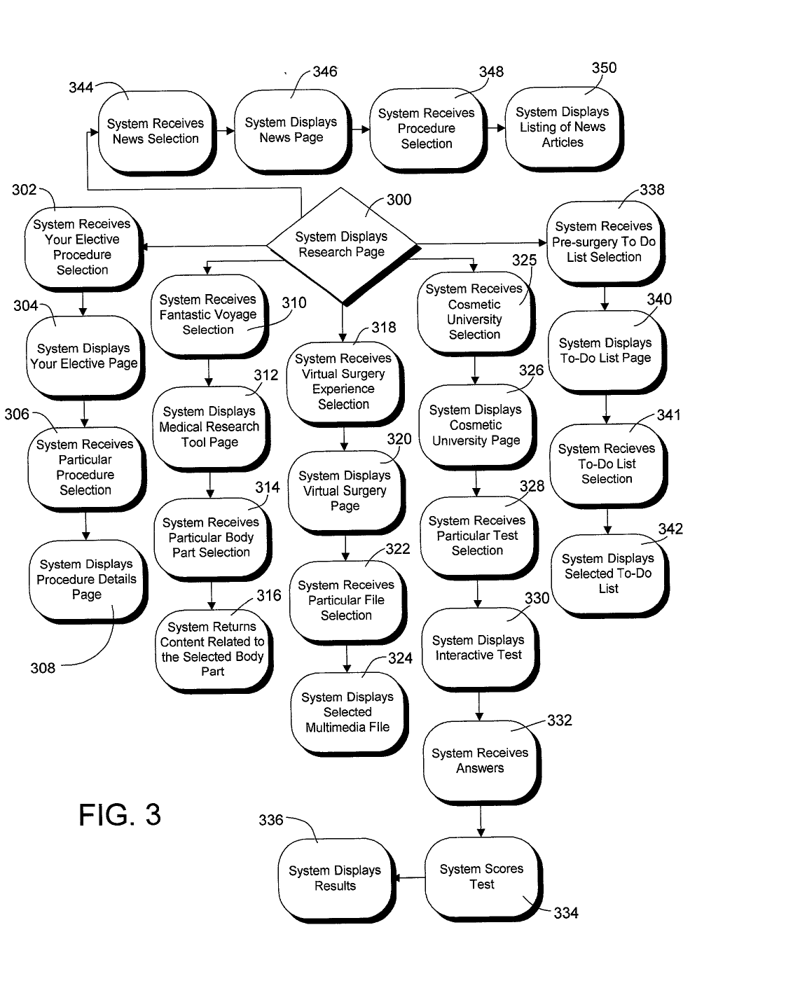

In accordance with the above-described options, detailed description of each option will now be set forth below. In step 204, the system receives a user selection of a conduct research option. Upon receipt of such a request, the system proceeds to step 300 of FIG. 3, and displays a research web page to the user. Preferably, the procedure research page includes a listing of all available options related to medical procedure research described above. Preferably these options include: 1) a your elective procedure option that provides searchable facts and information about a variety of elective surgery procedures; 2) a fantastic voyage option that provides a detailed description of the various body parts subject to elective procedures; 3) a virtual surgery experience option that provides streaming audio and/or video files of various elements of the offered procedures; 4) a cosmetic university option that provides a readiness test for prospective patients; 5) a pre-surgery to-do list option that provides a surgery preparation guide to prospective patients; and 6) a news option that provides recent relevant news articles to the user.

Relating to the your elective procedure option, the system receives, in step 302, a user selection of the your elective procedure option. In response, the system, in step 304, displays a your elective procedure page listing a plurality of medical procedures for which information is provided. Examples of suitable procedures include: laser refractive vision correction surgery (LASIK); laser skin resurfacing; liposuction; breast augmentation surgery; eyelid procedures; facelifts; as well as any other commonly selected cosmetic or other medical procedure.

In step 306, the system receives a user selection of a particular procedure to research. Upon receipt of such a selection, the system, in step 308, displays at least one procedure details page included a detailed description of the procedure. Preferably, the at least one procedure details page includes information relating to: how the procedure is performed, the history of the procedure, any qualifications necessary to receive the procedure, possible results and long-term effects of the procedure, unabridged risks associated with the procedure, the technology behind the procedure, the equipment used in the procedure, reasonable expectations for the procedure, the typical patient experience, guidelines for selecting a surgeon, post-operative do's and don'ts, possible enhancements to the selected surgery, and any additional information or types of information useful to prospective patients in assisting the decision-making process.

In a preferred embodiment, the procedure detail information is provided in a user-friendly manner utilizing multiple hyperlinks and distinct content pages. Further, the descriptive content may be displayed in many forms of multimedia content, such as audio clips, video clips, pop-up windows. java applets, and the like. In this manner, the system maximizes the multimedia capabilities of modern computer systems and the Internet to educate prospective patients.

Regarding the fantastic voyage option displayed to the user in step 300, if a user selects the fantastic voyage option from the research web page, the system, in step 310, receives a request corresponding to the selection. In step 312, the system displays a page directed toward a general medical research tool wherein users select particular parts of the body to learn about. Preferably, the body parts available for review are related to the medical procedures associated with the system, however, this is not required. In step 314, the system receiving a user selection of a particular body part, such as the eye. Following such a selection, the system, in step 316, returns content designed to enable the user to explore the selected body part including an explanation of how the body part works and what its various functions are. In this manner, a user is educated not just about a particular medical procedure, but also about the underlying body part that the procedure is performed upon. As with the type of content described above, various forms of multimedia content are contemplated including the aforementioned audio clips, video clips, pop-up windows. java applets, and the like.

Regarding the virtual surgery experience option displayed to the user in step 300, if a user selects the virtual surgery experience option from the research web page, the system, in step 318, receives a request corresponding to the selection. In step 320, the system displays a page directed toward the virtual surgery option, which includes at least a descriptive listing of multimedia files containing video footage of various medical procedures. In a preferred embodiment, both patient's view and surgeon's view files will be available for viewing. In step 322, the system receives a user request to view a particular multimedia file listed on the page displayed in step 320. In response to this request, the system, in step 324, displays video footage of various phases of a selected medical procedure using appropriate technology resident on the client computer system. For patient's view selections, footage may include preoperative testing, surgical preparation, and post-operative procedures as well as the view the patient sees during surgery i.e. laying on the operating table and fixating on a light or similar views during different types of cosmetic surgeries. Conversely, for surgeon's view selections, footage may include video of the actual the medical procedure being performed from the surgeon's perspective. Using LASIK laser eye surgery as an example, the video file may show the camera view that the surgeon sees during the actual surgery. This type of research material substantially increases the prospective patients preparation without requiring surgeons to exhaust individual resources in making such footage available for individual patients.

Regarding the cosmetic university option displayed to the user in step 300, if a user selects the cosmetic university option from the research web page, the system, in step 325, receives a request corresponding to this selection. In step 326, the system displays a page directed toward various medical procedure preparedness tests including a listing of the specific tests available for the various surgical procedures. In step 328, the system receives a user selection of a specific test. In response to this selection, the system, in step 330, displays an associated interactive test to the user for completion. Preferably, each test is prepared by doctors or other medical professionals skilled in the selected procedure and is designed to test the prospective patient's understanding of the surgical procedure and to preliminarily test the patient's suitability for the selected procedure. In a preferred embodiment, each test includes questions in either multiple choice or true/false format so as to facilitate prompt scoring by the system and feedback to participating users. In step 332, the system receives the user's submitted answers. Once the system receives the user's answers to the test questions, the system, in step 334, scores the test and, in step 336, displays a results page to the user. The results page goes over the correct answers to the test questions and preferably generates a printable diploma upon achievement of a predetermined test score. In an additional embodiment, a user's test score is used to acquire points redeemable for giveaways and other benefits.

Relating to the pre-surgery to do list option displayed in step 300, the system, in step 338, receives a user selection of the pre-surgery to do list option. In response, the system, in step 340, displays a listing of available to do lists for particular procedures. In step 341, the system receives a user selection of a particular list. Upon receipt of the list selection, the system, in step 342, displays the selected to do list to the user in the form of a guide designed to meet several objections. In particular, the guide is designed to provide users with a description of a good candidate for the procedure, a descriptive listing of all necessary and/or preferred preoperative precautions have been taken by the patient prior to surgery, and a printable surgeon check list designed to enable the patient to determine whether his or her surgeon has done everything necessary to ensure the best possible outcome. By providing specific details related to preferred candidates and preoperative procedures, patients are placed in a better position to both evaluate their suitability for the selected procedure as well as the thoroughness of their surgeon.

Relating to the news option displayed in step 300, the system, in step 344 receives a user request to view relevant news articles. In step 346, the system displays a listing of procedures for which news items are available. In step 348, the user selects a particular procedure and, in step 350, the system displays a listing of recent articles related to the selected procedure. Preferably, the article titles are hyperlinks which, when selected by a user, direct the user to the appropriate article text. It is contemplated that periodically, news articles will be removed from the news section and will be placed in a searchable news archive subsequently available to users. Preferably, each article will be available in the news section for at least one week. Further, it is contemplated that the content for the news articles may be provided by affiliated third party contributors.

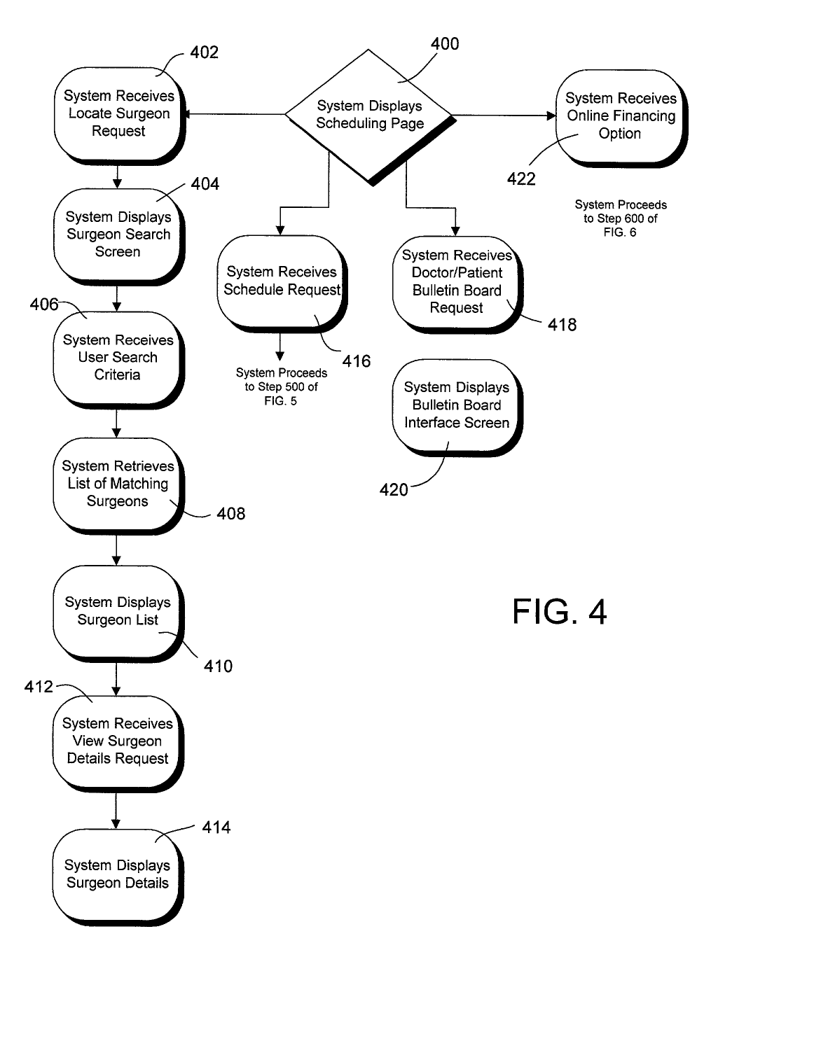

Referring now back to FIG. 2, the system, in step 206, receives a user request to view a procedure/consultation scheduling page. In response, the system proceeds to step 400 of FIG. 4, where a scheduling page is displayed to the user. In particular, the scheduling page preferably includes a plurality of user options related to scheduling and preparing for consultations and/or procedures. One preferred embodiment of the scheduling page displayed in step 400 provides the following discrete options: 1) a surgeon locator option which enables users to search for suitable doctors based upon various, user-definable search criteria; 2) a surgery scheduling option that enables users to schedule a consultation or surgery with an affiliated surgeon completely in an on-line environment; 3) a doctor-patient bulletin board option that enables general discussion between prospective patients and doctors as well as more direct and isolated interaction between doctors and their patients; and 4) an on-line financing option that enables prospective patients to apply for financing from affiliated financial institutions within the confines of the web site.

In step 402, the system receives a user request to locate a surgeon. In step 404, the system displays a surgeon search screen to the user. Preferably, the surgeon search screen includes an interface suitable for enabling a user to enter search criteria such as geographic location, practice area, past surgical experience, and sex. In step 406, the system receives user search criteria and, in step 408, retrieves a list of surgeons matching the input criteria. Preferably, a plurality of surgeons are affiliated with the system and details related to the affiliated surgeons are stored on at least one database associated with the system. In a known manner, input criteria may be applied against the previously stored surgeon information to obtain matching results.

In step 410, the system displays the list of matching surgeons to the user and enables the user to view surgeon details or schedule a consult or surgery with a listed surgeon. In step 412, the system receives a user request to view a selected surgeon's specific details and background. In response, the system, in step 414, displays such details to the user. Preferably, such details are designed to include information such as the surgeon's curriculum vitae, their surgical experience (including the number of procedures performed), as well as any relevant personal information about the surgeon useful to prospective patients.

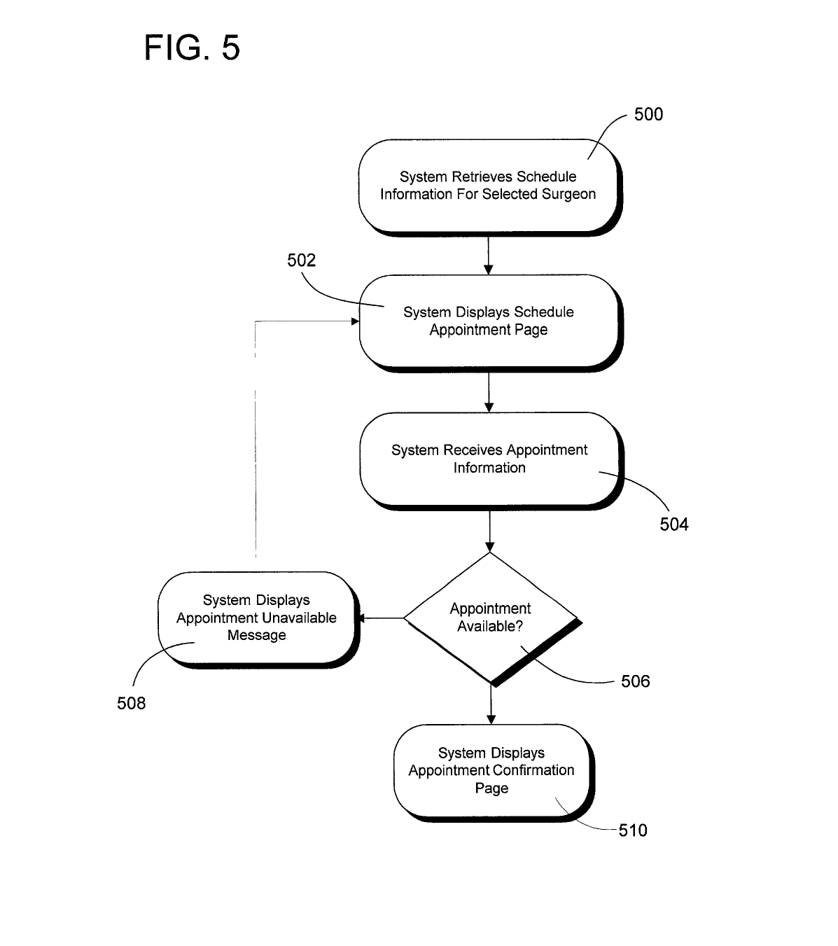

In step 416, the system receives a user request to schedule an appointment with a surgeon, either for a consultation or for a surgical procedure. It is envisioned that this request may come from either the surgeon results screen displayed in step 410 or from the scheduling page displayed in step 400, however any suitable initiation point is within the scope of the present invention. In response, the system proceeds to step 500 of FIG. 5, where the scheduling process is described in additional detail. In step 500, the system retrieves schedule information for a selected surgeon from the at least one database. Preferably, the schedule information is continually updated so as to reflect the selected surgeon's actual schedule. In step 502, the system displays a schedule appointment page for the selected surgeon. Preferably, the schedule appointment page includes a calendar style interface designed to enable the prospective patient to select an appointment time and date based upon surgeon availability. Further, the interface also enables the user submit personal information and patient information and also enables the user to indicate what type of procedure they are interested in and whether they have visited the particular surgeon before. All of this information is provided in a common interface, thereby enabling users to more easily set up appointments and provide the necessary information.

In step 504, the system receives the submitted appointment and patient information and, in step 506, compares this information against the schedule information available for the selected surgeon. If the appointment is unavailable, the system, in step 508, displays a message indicating that the appointment is unavailable and that the user should select another appointment time, returning the user to step 502.

However, if the appointment is available, the system proceeds to step 510 where a confirmation message is displayed to the user. Preferably, the system also provides a synchronization option enabling users to insert the appointment into their personal calendaring application such as Microsoft Outlook, from Microsoft Corporation or a Palm series hand-held organizer available from Palm, Inc. In this manner, the system provides streamlined online scheduling of medical appointments and procedures with reduced likelihood that the user will miss the appointment.

Relating to the doctor/patient bulletin board option displayed in step 400, the system, in step 418, receives a user selection of a doctor/patient bulletin board option. In step 420, the system displays a bulletin board interface screen to the user. In a known manner, the bulletin board enables the user to submit and read messages to other bulletin board participants. Further, it is contemplated that users of the bulletin board can easily move to a side chat room to have more personal conversations, and can easily and readily return to the bulletin board while chatting in private rooms.

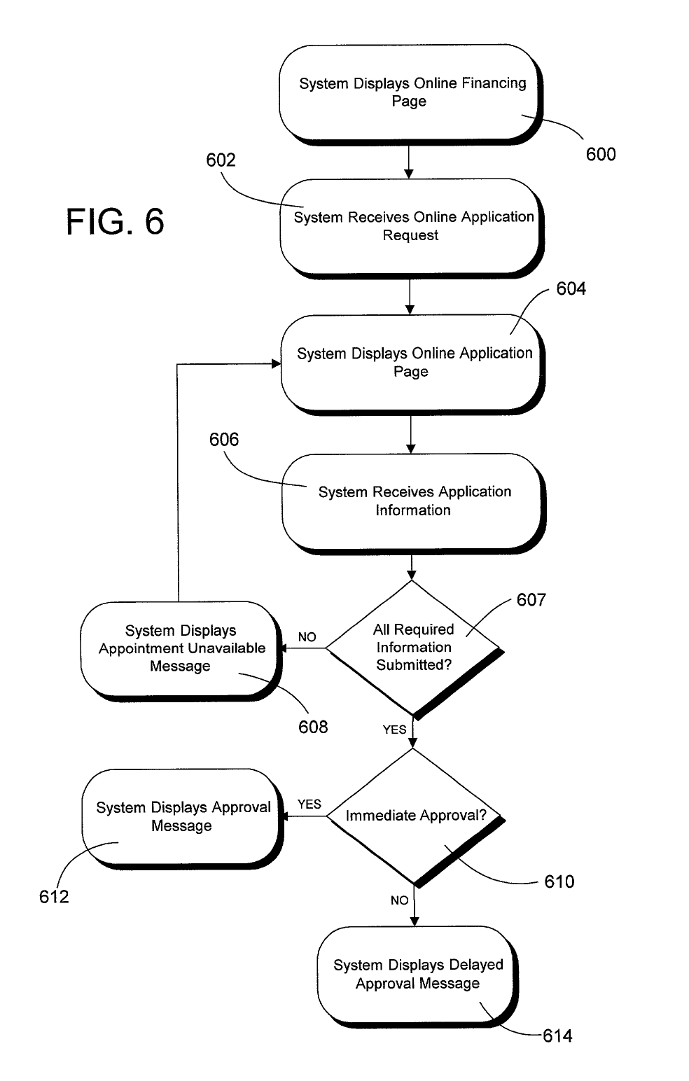

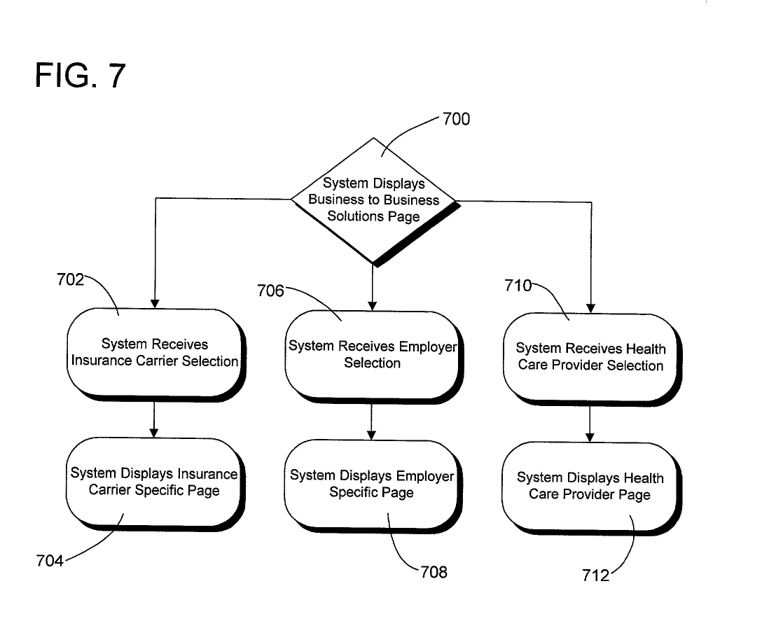

In step 422, the system receives a user selection of an online financing option. In response, the system proceeds to step 600 of FIG. 6, showing one method for providing online financing of medical procedures over a computer network in associating with the system of the present invention. In step 600, the system displays a online procedure financing page including a description of the available financing programs and including a option to apply for financing online. In step 602, the system receives a user request to apply for online financing from a selected financial institution. Upon receipt of such request, the system, in step 604, displays an online financing application page preferably including a plurality of interactive data entry fields relating to the prospective patient's personal and financial information such as the applicant's social security number and residency and contact information. As is known in the art, such forms generally contain both optional and required fields. In step 606, the system receives information submitted by the user and, in step 607, the system determines whether all required information has been submitted. If all required information has not been submitted, the system generates an appropriate error message in step 608 and returns the user to step 604 where the necessary information may be submitted.

If all required information has been received in step 606, the system, in step 610, determines whether an immediate approval can be made. If so, the system generates and displays an approval message in step 612 including a confirmation number and any necessary additional information. However, if the system determines that immediate approval can not be made, the system, in step 614 displays an appropriate message indicating that an immediate decision cannot be made and informing the user that written notification of credit approval or denial would be sent via conventional mail within due course.

In an alternative embodiment, rather than provide an affiliation to a single financial institution, the system of the present invention may enable multiple lending or other financial institutions to position competitive advertising on the web site. In this manner, prospective patients may shop for lower financing available financing rates.

In addition to patient related content and information, the system of the present invention also provides substantial advantages to businesses in the area of personnel benefits management. In particular, a preferred embodiment of the present invention includes a business to business option. In step 208, the system receives a selection of a business to business solutions option. In response, the system proceeds to step 700 of FIG. 7 where there is shown one embodiment for facilitating elective procedure benefit implementation over a computer network. In step 700, the system displays a business to business solutions page to the user. Preferably, the business to business solutions page includes options relating to the various types of businesses who may be interested in elective procedure benefits, including insurance carriers, employers, and health service providers. If the system, in step 702, receives a user selection of an insurance carrier option (thereby designating themselves as an insurance carrier), the system, in step 704, displays an insurance carrier specific page including information regarding elective procedure benefits and preferably including a listing of competing carriers who offer such coverage as well as employers who subscribe or desire to subscribe to such coverage and health care providers who honor or participate in such plans. The insurance carrier specific page also preferably enables insurance carriers to contact participating employers regarding such coverage.

If the system receives a user selection of an employer option in step 706, the system, in step 708, displays an employer specific page including general information relating to elective procedure benefits as well as a listing of insurance carriers providing such coverage and a listing of health care providers honoring the coverage. Preferably, the user is enabled to contact any listed company to either pursue a relationship or inquire as to the coverage.

Similarly, if the system, in step 710, receives a user selection of a health care provider option, the system, in step 712, displays a health care provider specific page including general information relating to elective procedure benefits as well as a listing of insurance carriers providing such coverage and a employers subscribing to the coverage. Preferably, the user is enabled to contact any listed company to either pursue a relationship or inquire as to the coverage.

By providing a forum for elective procedure insurance coverage discussion, the system of the present invention facilitates the expansion of such offerings thereby enhancing the ability for companies to become or stay competitive in the various related markets.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

We claim:

1. A method for enabling interactive research and scheduling of medical procedures over a computer network comprising the steps of:
displaying, to a client computer associated with a user, a listing of a plurality of medical procedure reference relating to at least one medical procedure;
receiving, from the client computer, a request to view a selected one of the plurality of medical procedure references relating to a particular medical procedure;
retrieving, from at least one database associated with a server computer, the selected one of the plurality of medical procedure references;
displaying the selected one of the plurality of medical procedure references to the client computer;
receiving, from said client computer, a request to schedule an appointment relating to the particular medical procedure;
receiving, from said client computer, appointment information relating to said appointment; and
displaying an appointment confirmation to said client computer.

2. The method of claim 1, wherein said step of displaying a listing of a plurality of medical procedure reference relating to at least one medical procedure, further comprises the steps of:
displaying a plurality of information content options, wherein each of the information content options includes at least one medical procedure reference related to at least one medical procedure;
receiving a user selection of a particular information content option;
displaying a listing of the medical procedures having medical procedure references of the particular information content option;
receiving a user selection of a particular medical procedure having at least one medical procedure references of the particular information content option;
displaying a listing of the medical procedure references for the particular medical procedure;
receiving a user request of a particular medical procedure reference; and
displaying the particular medical procedure reference to the user.

3. The method of claim 2, wherein the step of displaying a plurality of information content options, wherein each of the information content options includes at least one medical procedure reference related to at least one medical procedure, further comprises the steps of:
displaying a your elective procedure option;
displaying a fantastic voyage option;

4. A system for providing a medical procedure information and scheduling service over a computer network, comprising:
at least one server computer associated with a medical procedure information and scheduling content provider;
a plurality of client computers associated with a plurality of users, said plurality of client computers being connected to said at least one server computer over the computer network; and
a medical procedure information and scheduling web site hosted on said server for providing said users with access to medical procedure information and scheduling services,
wherein said medical procedure information and scheduling web site receives, from said user, a request to view medical procedure information relating to at least one medical procedure,
wherein said medical procedure information and scheduling web site retrieves, from at least one database associated with said server computer, medical procedure information relating to said information request,
wherein said medical procedure information and scheduling web site displays said medical procedure information to said client computer,
wherein said medical procedure information and scheduling web site receives, from said client computer, a request to schedule an appointment relating to said medical procedure,
wherein said medical procedure information and scheduling web site receives, from said client computer, appointment information relating to said appointment; and
wherein said medical procedure information and scheduling web site displays an appointment confirmation to said client computer.
